(19) United States
(12) Patent Application Publication
(10) Pub. No.: US 2014/0263526 A1
(43) Pub. Date: Sep. 18, 2014

(54) VERTICAL PACKAGING WRAP CUTTER

(71) Applicant: Hsiu-Man YU CHEN, Taichung (TW)

(72) Inventor: Hsiu-Man YU CHEN, Taichung (TW)

(21) Appl. No.: 13/803,597

(22) Filed: Mar. 14, 2013

(51) Int. Cl. B26F 3/02

(52) U.S. Cl. CPC B26F 3/02
USPC 225/39

(57) ABSTRACT

A vertical packaging wrap cutter includes a movable base installed with a first castor set to move it. A load unit and a cutting unit are vertically fixed on the movable base. By means of the first castor set, a user can easily move the cutter if necessary. And with the load unit and the cutting unit vertically fixed on the movable base, the size of the movable base can be shrunk, further convenient for a user to move the cutter.

### BACKGROUND OF THE INVENTION

1. Field of the Invention

This invention relates to a vertical packaging wrap cutter.

2. Description of the Prior Art

To stow away and deliver conveniently, packaging materials like bubble wrap and film wrap are usually formed as rolls. And as shown in FIG. 1, a conventional packaging wrap cutter invented by the present inventor includes a base 1, a shaft 2 pivotally fixed and aligned with the base 1, a cutting frame 3 fixed with the base 1, and a blade 4 movably engaged with the cutting frame 3. In using, a packaging roll 5 is first loaded on the shaft 2, with part of packaging wrap 6 pulled out of the packaging roll 5 to pass through the cutting frame 3. Then the blade 4 is moved to cut off the packaging wrap 6 needed.

The conventional cutter can swiftly provide a piece of flat packaging wrap 6 cut off the packaging roll 5, well-received by the market. However, as the base 1 is not collapsible, it has to be lifted up manually to make displacement. Moreover, with the shaft 2 and the cutting frame 3 horizontally fixed with base 1, the base 1 together with the shaft 2 and the cutting frame 3 possesses a rather large dimension, difficult for a user to move it.

### SUMMARY OF THE INVENTION

The object of this invention is to offer a vertical packaging wrap cutter, able to quickly give a piece of flat packaging wrap cut off a packaging roll, moved easily by a user.

The main characteristics of the invention are a movable base, a load unit and a cutting unit. The movable base is provided with a positioning frame installed with a first castor set to move it. A pivotal hole is provided in the positioning frame. The load unit is provided with a shaft vertically fitted in the pivotal hole, and at least a fixing sleeve and a fastener fitted on the shaft. The cutting unit is provided with a frame vertically fixed on the positioning frame, a sliding rod installed in the frame to parallel with the shaft, a lengthy hole bored near the sliding rod, a blade base movable on the sliding rod, and a blade fixed on the blade base in association with the lengthy hole.

By loading a packaging roll on the shaft, pulling part of the packaging wrap out of a packaging roll, and moving the blade base to enable the blade to operate cutting, the present cutter can swiftly supply a piece of flat packaging wrap. With the first castor set, the shaft 2 and the cutting frame 3 laterally fixed with the base 1, the base 1 together with the shaft 2 and the cutting frame make up a large dimension and weight, very inconvenient for a user to transport. So the conventional packaging wrap cutter should be improved.

### BRIEF DESCRIPTION OF DRAWINGS

This invention is better understood by referring to the accompanying drawings, wherein:

FIG. 1 is a perspective view of a conventional packaging wrap cutter;

FIG. 2 is a perspective view of a preferred embodiment of a vertical packaging wrap cutter in the present invention;

FIG. 3 is an exploded perspective view of the preferred embodiment of a vertical packaging wrap cutter in the present invention;

FIG. 4 is a cross-sectional view of the “4-4” line in FIG. 2; and

FIG. 5 is a perspective view of the preferred embodiment of a vertical packaging wrap cutter in the present invention, showing it being operated.

### DETAILED DESCRIPTION OF THE PREFERRED EMBODIMENT

As shown in FIGS. 2 and 3, a preferred embodiment of a vertical packaging wrap cutter 100 in the present invention is composed of a movable base 10, a load unit 20, a cutting unit 30, at least a bolster rod 40 and a blade lever 50.

The movable base 10 is provided with a polygonal positioning frame 11, plural wings 12 extended outward from the positioning frame 11, and a pivotal hole 13 located on the positioning frame 11 and a bearing is used as the pivotal hole 13 in the present embodiment. Further, a first castor set 14 is installed under the positioning frame 11 to move it. In this embodiment, the first castor set 14 is provided with plural one-direction castors 141 combined aside with the positioning frame 11, and plural steerable castors 142 combined under the wings 12. Each of the steerable castors 142 is installed with a brake 143. Positioned on the top of the positioning frame 11 is a second castor set 15, which is provided with plural castors 151 spaced apart appropriately around the circumference of the positioning frame 11, rotatable in a direction parallel to the edge of the positioning frame 11. And a turntable 16 is laid on the second castor set 15, bored with a pivotal hole 161 corresponding to the pivotal hole 13.

The load unit 20 is provide with a shaft 21 vertically fitted on the pivotal hole 13, and at least a fixing sleeve 22 and a fastener 23 fitted on the shaft 21. In this embodiment, the shaft 21 is primarily inserted through the pivotal hole 161 and pivotally fitted with the pivotal hole 13, and fitted with two fixing sleeves 22 and one fastener 23.

The cutting unit 30 is placed in a frame 31 vertically fixed on the positioning frame 11, a sliding rod 32 installed in the frame 31 to parallel with the shaft 21, a lengthy hole 33 bored near the sliding rod 32, and a blade base 34 movable on the sliding rod 32. Further, as shown in FIG. 4, the blade base 34 is fixed with a blade 35 in association with the lengthy hole 33.

The bolster rod 4 has two ends respectively connected with the shaft 21 and the frame 31, positioned near the top of the shaft 21 and the frame 31 in this embodiment.

The blade lever 50 is provided with a connecting portion 51 formed at one end to pivotally connect with the blade base 34, and a grip 52 formed at another end.

In using, as shown in FIG. 5, a packaging roll 200 has to be inserted in the shaft 21, with the fixing sleeves fitted in two ends of the packaging roll 200 respectively. Next, the fastener 23 is tightened to restrict the fixing sleeve 22, so that the packaging roll 200 can stay steadily on the shaft 21. Then a part of packaging wrap 201 can be pulled out of the packaging roll 200 to pass through the lengthy hole 33 of the frame 31. Finally, with the blade lever 50 pulled to enable the blade base 34 to move along the sliding rod 32, the packaging wrap 201 can be cut off the packaging roll 200.

If the vertical packaging wrap cutter 100 is to be moved to another spot, a user just needs to release the brakes 143 from the steerable castors 142 so that the positioning frame 11 can be easily moved by means of the castors 141 and 142. And the brakes 143 can be pressed to lock the steerable castors 142 again after the cutter 100 is moved to a new location.

Therefore the present cutter 100 can not only quickly cut off a piece of flat packaging wrap 201 from the packaging roll 200, but also be easily moved to another spot as the first roller set 14 is installed with the positioning frame 11.

It should be noted that with the load unit 20 and the cutting unit 30 vertically installed on the movable base 10, the size of the movable base 10 can be largely shrunk, making the present cutter 100 more easily to be moved.

Moreover, with the turntable 16 deposited on the second castor set 15, the weight of the packaging roll 200 loaded on the shaft 21 can be dispersed among the turntable 16. And as the packaging wrap 201 is being pulled out of the packaging roll 200, the turntable 16 can rotate smoothly as being assisted by the second castor set 15, so that the shaft 21 can whirl more steadily, causing less rotating bias.

And with the bolster rod 40 fixed at the top of the shaft 21 and the frame 31, it can further boost rotating steadiness of the shaft 21. With the blade lever 50 combined with the blade base 34, a user can naturally stand to drive the blade base 34 along the sliding rod 32 up and down, convenient for practical operation. With the steerable castors 142 positioned under the wings 12 protruded outside the turntable 16, a user can conveniently operate the brakes 143.

While the preferred embodiment of the invention has been described above, it will be recognized and understood that various modifications may be made therein and the appended claims are intended to cover all such modifications that may fall within the spirit and scope of the invention.

What is claimed is:

1. A vertical packaging wrap cutter comprising:
a movable base provided with a positioning frame, a first castor set installed under said positioning frame to move it, a pivotal hole formed in said positioning frame;
a load unit provided with a shaft vertically fixed on said pivotal connector, at least a fixing sleeve and a fastener 23 fitted on said shaft; and
a cutting unit provide with a frame vertically fixed on said positioning frame, a sliding rod installed in said frame to parallel with said shaft, a lengthy hole bored near said sliding rod, a blade base movable on said sliding rod, a blade fixed on said blade base to correspond to said lengthy hole.

2. The vertical packaging wrap cutter as claimed in claim 1, wherein a second casstor set is positioned on said positioning frame, a turntable laid on said second castor set and bored with a pivotal hole for said shaft to pass through to pivotally fit with said pivotal hole.

3. The vertical packaging wrap cutter as claimed in claim 2, wherein said positioning frame is formed polygonal, said second castor set provided with plural castors spaced apart appropriately around a circumference of said positioning frame and rotatable in a direction parallel to an edge of said positioning frame.

4. The vertical packaging wrap cutter as claimed in claim 1, wherein plural wings are extended outward from said positioning frame, said first castor set provided with plural one-direction castors installed aside with said positioning frame and plural steerable castors combined under said wings.

5. The vertical packaging wrap cutter as claimed in claim 4, wherein each of said steerable castors is provided with a brake.

6. The vertical packaging wrap cutter as claimed in claim 1, wherein at least a bolster rod is further provided, having two ends respectively connected with said shaft and said frame.

7. The vertical packaging wrap cutter as claimed in claim 1, wherein said cutter is further provided with a blade lever having one end formed as a connecting portion to pivotally connect with said blade base and another end formed as a grip.

8. The vertical packaging wrap cutter as claimed in claim 1, wherein said pivotal hole is a bearing.
